(19) United States
(12) Patent Application Publication
(10) Pub. No.: US 2013/0346601 A1
(43) Pub. Date: Dec. 26, 2013

(54) NETWORK DEVICE, METHOD OF CONTROLLING THE NETWORK DEVICE, AND NETWORK SYSTEM

(71) Applicants: HONDA MOTOR CO., LTD., Tokyo (JP); HITACHI HIGH-TECHNOLOGIES CORPORATION, Tokyo (JP)

(72) Inventors: Daisuke ITO, Tokyo (JP); Yuji NIIHARA, Saitama (JP)

(21) Appl. No.: 13/922,559

(22) Filed: Jun. 20, 2013

(30) Foreign Application Priority Data
Jun. 25, 2012 (JP) 2012-142354

(51) Int. Cl. H04L 12/70

(52) U.S. Cl. CPC H04L 47/10
USPC 709/224

(57) ABSTRACT

In a proxy device that can sufficiently speed up a communication of a TCP, and is easily introduced into an existing environment, a device that can multiplex the TCP is provided. The device includes a storage area A that holds respective moving averages of a request rate for each TCP connection, and an output rate at which transfer to a network could be conducted, and a storage area B that holds the number of divided connections for each connection requested by a host, and identification information on each of the divided connections. The number of divided connections is increased or decreased according to the request rate and the output rate of the storage area A. When the number of divided connections is increased, a new TCP connection C starts, and the number of divided connection in the storage area B, and the identification information on the connection C are updated.

### CLAIM OF PRIORITY

The present application claims priority from Japanese patent application JP 2012-142354 filed on Jun. 25, 2012, the content of which is hereby incorporated by reference into this application.

### BACKGROUND OF THE INVENTION

1. Field of the Invention

The present invention relates to a network device, a method of controlling the network device, and a network system, and more particularly to a network device, a method of controlling the network device, and a network system which multiplex TCP on a proxy device to speed up a communication.

2. Description of the Background Art

When a plurality of information communication devices communicate with each other, a transmission control protocol (TCP) defined by RFC 793 (“TRANSMISSION CONTROL PROTOCOL, DARPA INTERNET PROGRAM, PROTOCOL SPECIFICATION”, pages 3-6, sec. 1.5, “Flow Control”, http://datatracker.ietf.org/doc/rfc793) is generally used. The TCP is substantially a standard protocol on the internet, and installed in a large number of communication devices. With the use of the TCP, the information communication devices can communicate with each other regardless of the type of the information communication devices.

### [WAN Speed-Up Device]

However, when a communication is conducted between a data center and a hub through a wide area network (WAN), an effective bandwidth is bottlenecked by a delay of the WAN from the restrictions of a flow control of the TCP, as a result of which even if a contracted bandwidth of the WAN is widened, the speed-up effect may not be obtained. Under the circumstance, there has been proposed a TCP speed-up technique for improving the flow control of the TCP in a network proxy device (device executing a communication by proxy). Also, the speed-up device of this type is called “WAN speed-up device”.

For example, JP-A-2003-69615 pertaining to a flow control improvement of the TCP discloses that “One or more routers 70a and 70b are arranged between a source host 50 and a destination host 60. The router 70a generates and transmits an acknowledge packet responsive to a packet transmitted from the source host 50, and terminates and divides a connection between the source host 50 and the destination host 60. An address of the destination host is used for a start address of the acknowledge packet. Also, a packet whose start address is an address of the source host is brought to the destination host 60. As a result, both of those hosts are made to recognize one virtual connection.” (refer to “technical solution”).

### [Device for Transmitting TCP in a Lump]

Also, as another technical solution to the problem that the effective bandwidth is not obtained from the restrictions of the flow control of the TCP when a communication is conducted between the data center and the hub through the wide area network, there has been proposed a method of changing a communication control system of a transmitter side communication terminal, and multiplexing the TCP.

For example, JP-A-2004-260668 discloses that “There is provided a moving image transmission system including a transmitting device that transmits moving image data required to be reproduced in real time by TCP/IP, and a receiving device that receives the data transmitted from the transmitting device. The transmitting device transmits divided image data obtained by further dividing individual unit image data with one frame or a plurality of frames of the moving image data as one unit through a plurality of TCP connections, and the receiving device has a buffer part that proceeds with the processing for returning the divided image data received through the plurality of TCP connections to the original unit image data, and storage of the moving image data for the plurality of frames, and determines the division number of unit image data, and the number of TCP connections on the basis of a throughput per one TCP connection and an average bit rate of the moving image data.” (refer to “technical solution”).

Further, a method of applying the TCP multiplexing to proxy is also provided. For example, in US2005/025150 (Accelerating Network Performance by Striping and Parallelization of TCP Connections), “The Proxy application runnning on network accelerator 14-1 then assigns one or more of the persistent connections it has with the network accelerator 14-2 to handle the connection requested by Machine A.” is disclosed (refer to paragraph [0031] in “Detailed Description of the Invention”).

### SUMMARY OF THE INVENTION

In the related art WAN speed-up device, in order to execute an arrival acknowledge by proxy, the proxy device is provided with a flow control window larger than that of clients, and the window is not used up even if the delay is somewhat long. However, in this system, because the window is used up under the circumstance where the delay is larger than an assumed delay, there still arises such a problem that a sufficient bandwidth is not obtained from the restrictions of the flow control of the TCP.

Accordingly, a first object of the present invention is to provide a WAN speed-up device that can sufficiently speed up a communication of the TCP.

Also, in the related art technique for changing the communication control system of the transmitter side communication terminal, there is a need to change the communication control system of all the sever terminals and the client terminals under the existing environment configured by the server client system, resulting in such a problem that the introduction of the above system into the existing environment is difficult.

Accordingly, a second object of the present invention is to provide a WAN speed-up device that can multiplex the TCP in a proxy device that can be easily introduced into the existing environment.

Also, in an example where the related art TCP multiplexing method is applied to the proxy device, when receiving a connection establishment request from the client, the connection divided into an appropriate division number, and subjected to the TCP multiplexing is established. However, because the number of multiplexing is statically determined according to a status at the time of requesting the connection establishment, there arises such a problem that it is difficult to always conduct an appropriate control according to the status of the network.

Accordingly, a third object of the present invention is to provide a WAN speed-up device that can multiplex the TCP which can dynamically control the number of multiplexing of the TCP according to the status of the network.

As described above, the present invention aims at providing a network device, a method of controlling the network device, and a network system which can speed up a communication of the TCP. Also, the present invention aims at providing a network device, a method of controlling the network device, and a network system which can multiplex the TCP in a proxy device that is easily introduced into the existing environment.

The present invention includes a plurality of technical solutions, and according to one example of those solutions, there are provided a storage area A that holds the respective moving averages of the request rate for each TCP connection, and the output rate at which transfer to the network could be conducted, and a storage area B that holds the number of divided connections for each connection requested by the host, and identification information on each of the divided connections. The request rate and the output rate in the storage area A are compared with each other according to a rule of a user definition or a system definition, and the number of divided connections is increased or decreased as the occasion demands. When the number of divided connections is increased, a new TCP connection C starts, and the number of divided connections in the storage area B, and the identification information on the connection C are updated. When the number of divided connections is decreased, an arbitrary TCP connection D is acquired from the storage area B, the TCP connection D is terminated, and the number of divided connections and the identification information on the connection C in the storage area B are updated and controlled.

With the above configuration, in this WAN speed-up device, only the TCP communication between the proxy devices is multiplexed without changing the communication control system of the server terminal and the client terminal in the existing environment, and the communication of the TCP between the client and the server can be sufficiently speeded up.

According to the first solving means of the present invention, there is provided a network device that relays a TCP communication through a first network and a second network between hosts, the network device comprising:

a first storage area that holds, for each TCP connection between the hosts, a request rate based on an amount of data input from the first network, and an output rate indicative of an effective bandwidth at which data is transferred to the second network;

a connection division coupling unit that, for each TCP connection between the hosts, divides data from the first network into a plurality of connections established with respect to an opposed network device in the second network, and transfers the divided connections, and couples data from the second network through the plurality of connections together, and transfers the coupled data to the first network;

a second storage area that holds the number of divided connections; and

a bandwidth monitoring unit that increases or decreases the number of divided connections on the basis of the request rate and the output rate.

According to the second solving means of the present invention, there is provided a method of controlling a network device that relays a TCP communication through a first network and a second network between hosts, the method including steps of:

storing, for each TCP connection between the hosts, a request rate based on an amount of data input from the first network, and an output rate indicative of an effective bandwidth at which data is transferred to the second network in a first storage area;

dividing, for each TCP connection between the hosts, data from the first network into a plurality of connections established with respect to an opposed network device in the second network, and transfering the divided connections, and coupling data from the second network through the plurality of connections together, and transfering the coupled data to the first network; and

increasing or decreasing the number of divided connections on the basis of the request rate and the output rate.

According to the third solving means of the present invention, there is provided a network system in which a first host and a second host communicate with each other through a wide area network, the network system comprising:

a first network device according to claim 1 which is arranged on the first host side; and

a second network device according to claim 1 which is arranged on the second host side, wherein

the first network device and the second network device are arranged through the wide area network, and

the first host and the second host communicate with each other through a connection divided on the basis of an effective bandwidth of the wide area network.

According to the fourth solving means of the present invention, there is provided a network system in which a first host and a second host communicate with each other through a wide area network, the network system comprising:

a first general purpose server device which is arranged on the first host side;

a second general purpose server device which is arranged on the second host side;

a first external storage medium that stores a program that executes a method according to claim 8, and related data therein, which is arranged on the first general purpose server device side; and

a second external storage medium that stores a program that executes a method according to claim 8, and related data therein, which is arranged on the second general purpose server device side, wherein

the first general purpose server device and the second general purpose server device are arranged through the wide area network,

the program and the related data are copied into the first general purpose server device from the first external storage medium,

the program and the related data are copied into the second general purpose server device from the second external storage medium, and

the first host and the second host communicate with each other through a connection divided on the basis of an effective bandwidth of the wide area network.

It is possible, according to the present invention, to provide a network device, a method of controlling the network device, and a network system which can speed up a communication of the TCP. Also, it is possible, according to the present invention, to provide a network device, a method of controlling the network device, and a network system which can multiplex the TCP in a proxy device that is easily introduced into the existing environment.

### BRIEF DESCRIPTION OF THE DRAWINGS

FIG. 1 is a diagram of an overall configuration according to a first embodiment;

FIG. 2 is a diagram illustrating an example of a schema and a record in a bandwidth DB according to the first embodiment;

FIG. 3 is a diagram illustrating an example of a schema and a record in a connection division number DB according to the first embodiment;

FIG. 4 is a flowchart from a connection start to a connection end;

FIG. 5 is a flowchart illustrating a bandwidth monitoring part according to the first embodiment;

FIG. 6 is a flowchart illustrating division transmission processing of the bandwidth monitoring part according to the first embodiment;

FIG. 7 is a flowchart of a connection division coupling part according to the first embodiment;

FIG. 8 is a flowchart of the division transmission processing of the connection division coupling part according to the first embodiment;

FIG. 9 is a flowchart of division receiving processing of the connection division coupling part according to the first embodiment;

FIG. 10 is a flowchart of bandwidth adjustment processing of the bandwidth monitoring part according to the first embodiment;

FIG. 11 is a flowchart of bandwidth adjustment processing A of the connection division coupling part according to the first embodiment;

FIG. 12 is a flowchart of bandwidth adjustment processing B of the connection division coupling part according to the first embodiment;

FIG. 13 is a diagram illustrating a connection start sequence according to the first embodiment;

FIG. 14 is a diagram illustrating a communication sequence of a steady state according to the first embodiment;

FIG. 15 is a diagram illustrating a connection end sequence according to the first embodiment;

FIG. 16 is a diagram illustrating a reviewing sequence of the number of divided connections according to the first embodiment;

FIG. 17 is a diagram illustrating an example of a schema and a record in a bandwidth DB according to a second embodiment;

FIG. 18 is a diagram illustrating an overall configuration according to a third embodiment; and

FIG. 19 is a diagram illustrating an overall configuration according to a fourth embodiment.

### DETAILED DESCRIPTION OF THE INVENTION

Hereinafter, embodiments will be described with reference to the accompanying drawings.

### First Embodiment

In this embodiment, a description will be given of an example of WAN speed-up devices 1011 and 1031 that equally speed up communications from, for example, all of terminals.

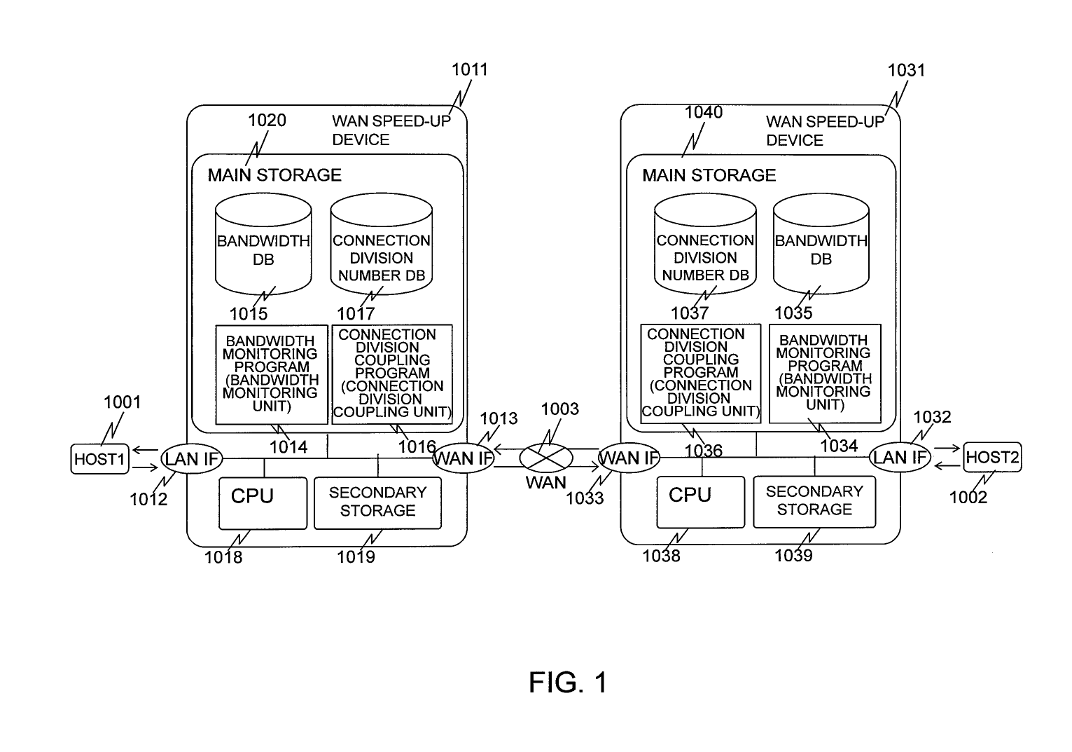

FIG. 1 is an exemplary configuration diagram of a communication system using a WAN speed-up device according to this embodiment. In FIG. 1, two hosts (communication device, terminal) of a host 1 (1001) and a host 2 (1002) communicate with each other through a LAN (first network) and a WAN (second network) (1003). On its path, the WAN speed-up devices (network devices) 1011 and 1031 operate as proxy devices. For example, the host 1 (1001) and the WAN speed-up device 1011 as well as the host 2 (1002) and the WAN speed-up device 1031 are installed physically close to each other, respectively, to reduce a network delay. The WAN speed-up device 1011 (and 1031) has a LAN interface 1012 (and 1032) and a WAN interface 1013 (and 1033) as external input and output. Also, in order to operate programs, the WAN speed-up device 1011 (and 1031) includes a CPU 1018 (and 1038), a main storage (main memory, main storage unit) 1020 (and 1040), and a secondary storage (secondary memory, secondary storage unit) 1019 (and 1039). The LAN interface 1012 (and 1032) and the WAN interface 1013 (and 1033) each have a buffer of a first in first out (FIFO, data first input is first output) system of about several KB to several MB. For that reason, the main storage 1020 (and 1040) can read data as large as a buffer size at a maximum from the LAN interface 1012 (and 1032) and the WAN interface 1013 (and 1033). Programs and databases (DB) are saved in the secondary storage 1019 (and 1039), and the programs and the DB are read by the main storage 1020 (and 1040) after the WAN speed-up device 1011 (and 1031) has started, and operated by the CPU 1018 (and 1038).

In the first embodiment, the programs include a bandwidth monitoring program 1014 (and 1034), and a connection division coupling program 1016 (and 1036). Hereinafter, a description will be given of a block in which the CPU 1018 (and 1038) executes and realizes the bandwidth monitoring program as the bandwidth monitoring unit 1014 (and 1034), and a block in which the CPU 1018 (and 1038) executes and realizes the connection division coupling program as the connection division coupling unit 1016 (and 1036). A control TCP connection is established between the two connection division coupling units 1016 and 1036 in advance. For example, the TCP connection can be distinguished from other connections by a method using, for example, a specific port No. or a specific IP address.

The main storage 1020 (and 1040) includes a bandwidth DB (first storage area) 1015 (and 1035), and a connection division number DB (second storage area) 1017 (and 1037). The bandwidth DB 1015 (and 1035) holds respective moving averages of a request rate for each of the TCP connections, and an output rate at which transfer to the network could be conducted.

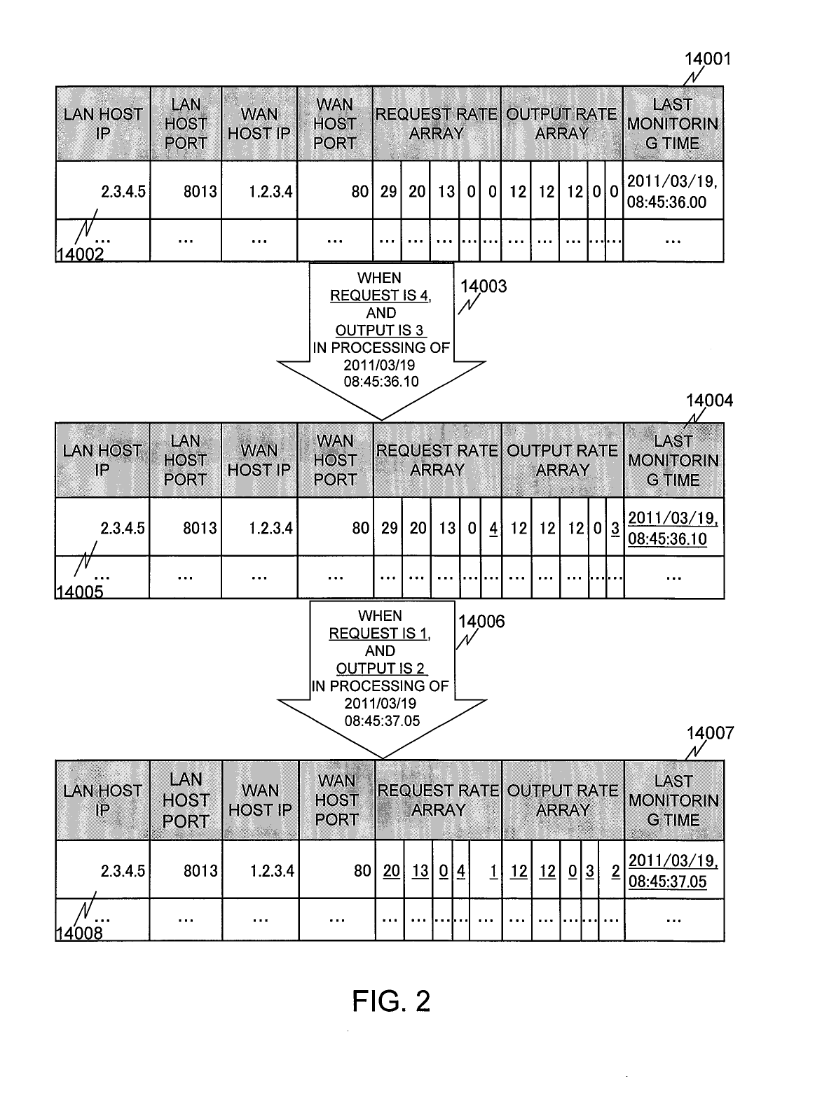

Referring to FIG. 2, a table 14001 illustrates an example of a schema and a record in the bandwidth DB 1015 (and 1035). The schema in the table 14001 combines four columns of a LAN host IP column, a LAN host port column, a WAN host IP column, and a WAN host port column together to distinguish the TCP connections from each other. That is, the table 14001 can search a row (entry) corresponding to a specified TCP connection. Also, in order to take, for example, a moving average of the request rates and the output rates for last 5 seconds, the table 14001 has an array structure of holding previous five values of the request rates and the output rates, and further holds a last monitoring time. In this embodiment, an acquisition period of the moving average is set to 5 seconds, but the acquisition period other than 5 seconds may be used as a value of a system definition or a user definition. Also, the obtained moving average may be further stored.

The request rate is, for example, the amount of data input within a unit time, or a value based on the amount of data. Also, the output rate represents, for example, an effective bandwidth at which the data is transferred within a unit time.

A method of updating a request rate array and an output rate array of the bandwidth DB 1015 (and 1035) will be described with reference to FIG. 2. An example in which the request rate and the output rate of a connection held on a row 14002 is used. At the row 14002, the last monitoring time is 2011/03/19, 08:45:36.00, and the request rate array represents that the request rate of 4 seconds ago, that is, for one second (unit time) from 2011/03/19, 08:45:32.00 is 29, the request rate of 3 seconds ago, that is, for one second from 2011/03/19, 08:45:33.00 is 20, likewise, the request rate of 2 seconds ago for one second is 13, the request rate of 1 second ago for one second is 0, and the request rate at present, that is, for one second from 2011/03/19, 08:45:36.00 is 0. Likewise, the output rate array represents that the output rate of 4 second ago for one second is 12, the output rate of 3 second ago for one second is 12, the output rate of 2 seconds ago for one second is 12, the output rate of 1 second ago for one second is 0, and the output rate at present for one second is 0. Several rate units are conceivable. In this embodiment, KB/sec is used, but other units, such as the number of packets/sec, may be used. Last one column of each of the request rate and the output rate arrays, that is, the output rate for one second from 2011/03/19, 08:45:36.00 does not represent the rate for one second because one second is not strictly elapsed, but called “rate for one second” for convenience in this example.

When the request of processing at 2011/03/19, 08:45:36.10 from this state is 4 KB, and the output thereof is 3 KB (14003), the table 14001 is changed to a table 14004. In this example, as indicated by a row 14005 corresponding to the row 14002, the last one column of the request rate array is updated to 0+4, that is, 4 KB, the last one column of the output rate array is updated to 0+3, that is, 3 KB, and the last monitoring time is updated to the present time, that is, 2011/03/19, 08:45:36.10. Thus, the last one column of each of the request rate and the output rate arrays is appropriately incremented, and the rate for one second is counted.

Subsequently, when the request of processing at 2011/03/19, 08:45:37.05 from this state is 1 KB, and the output thereof is 2 KB (14006), the table 14004 is changed to the table 14006. In this example, because a unit of second of the time is changed from 36 seconds to 37 seconds, both arrangements of the request rate and the output rate are shifted. Specifically, as indicated by a row 14008 corresponding to the row 14005, all of the values are shifted to the left by one, and on the respective last columns, that is, columns representing the present 1 second, the present request is 1 KB, and the present output is 2 KB. The request rate array and the output rate array of the bandwidth DB 1015 (and 1035) are updated as described above, and managed by, for example, the bandwidth monitoring unit 1014 (and 1034).

The connection division number DB 1017 (and 1037) holds the number of divided connections for each connection requested by the host, and identification information on each of the divided connections.

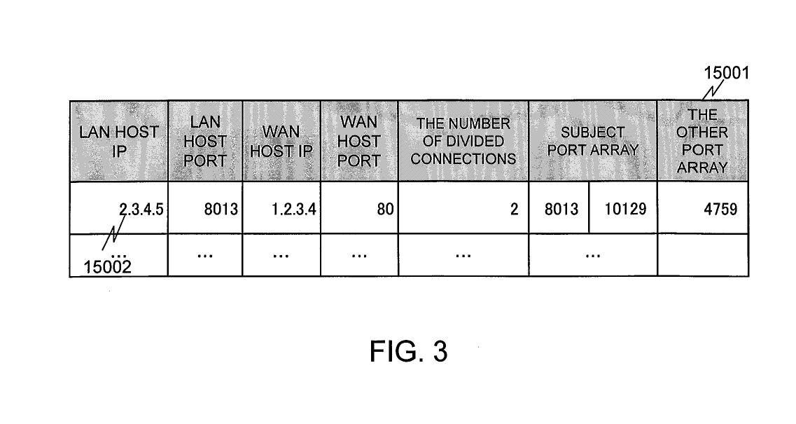

FIG. 3 illustrates a table 15001 of an example of the schema and the record in the connection division number DB 1017 (and 1037). The schema in the table 15001 combines four columns of a LAN host IP column, a LAN host port column, a WAN host IP column, and a WAN host port column together to distinguish the TCP connections from each other. Also, the number of divided connections between the WAN speed-up devices 1011 and 1031 is held in a column of the connection division number, and both-end port Nos. of each divided connection is held in a subject port array and the other port array. In this embodiment, when a connection between the WAN speed-up devices 1011 and 1031 is divided, the number of ports used in one WAN speed-up device is controlled to be always one. In this record, the number of ports on the other port side is set to one. For example, the connection division coupling unit 1016 (and 1036) updates the connection division number DB 1017 (and 1037) for management.

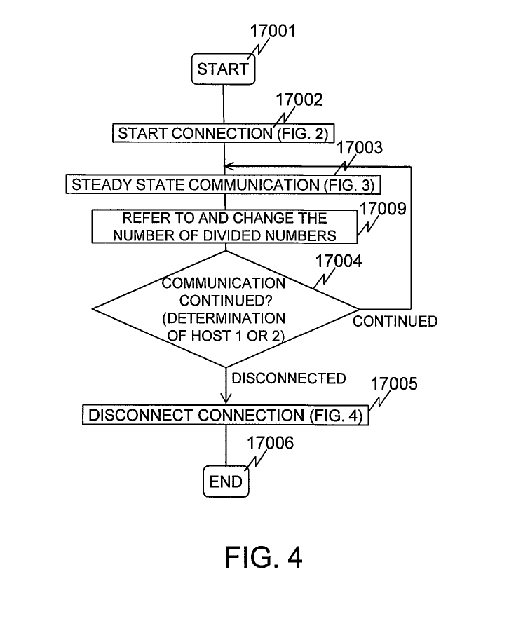

FIG. 4 illustrates a flow from a connection start to a connection end between the host 1 (1001) and the host 2 (1002).

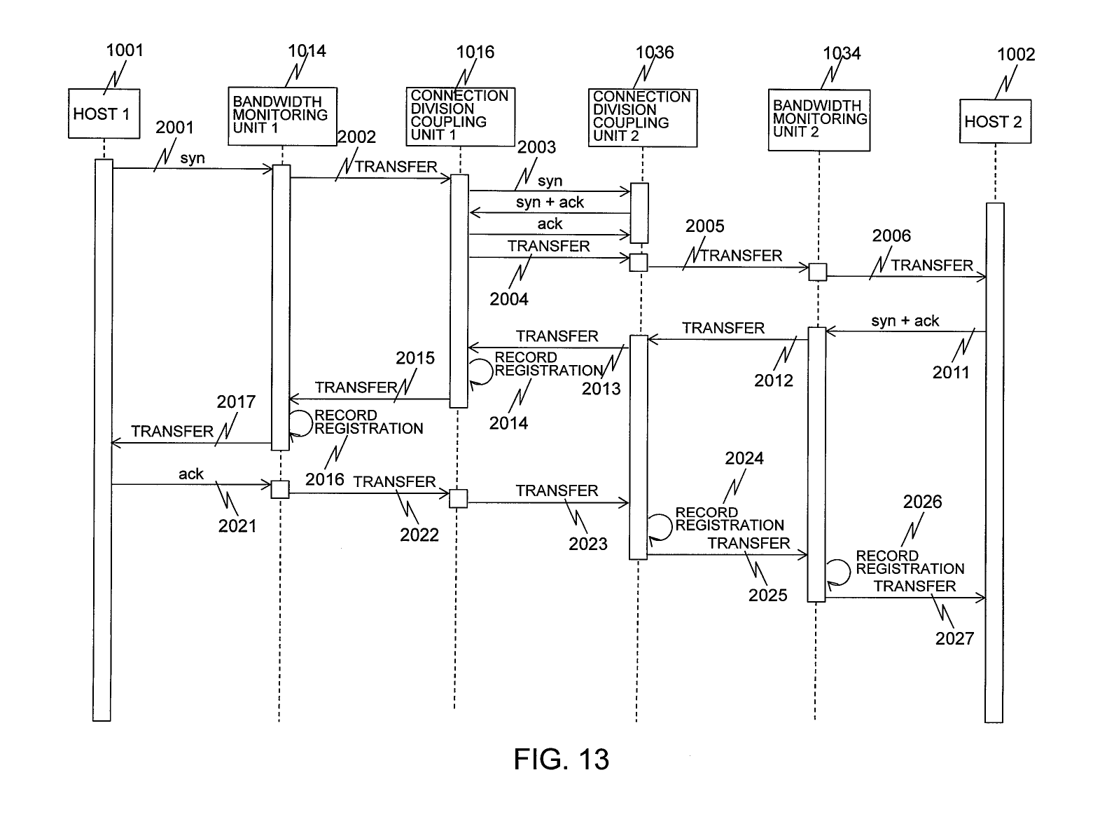

When the host 1 (1001) or the host 2 (1002) starts a communication (17001), connection start processing (17002) is first conducted to establish a connection between the host 1 (1001) and the host 2 (1002) through the WAN speed-up devices 1011 and the 1031. The details of this processing will be described with reference to FIG. 13. Subsequently, steady state communication processing (17003) is conducted between the host 1 (1001) and the host 2 (1002) to transfer data between the host 1 (1001) and the host 2 (1002). This processing is bidirectionally communicatable. That is, a communication from the host 1 (1001) to the host 2 (1002), and a communication from the host 2 (1002) to the host 1 (1001) are conducted regardless of which host starting the connection in step 17002.

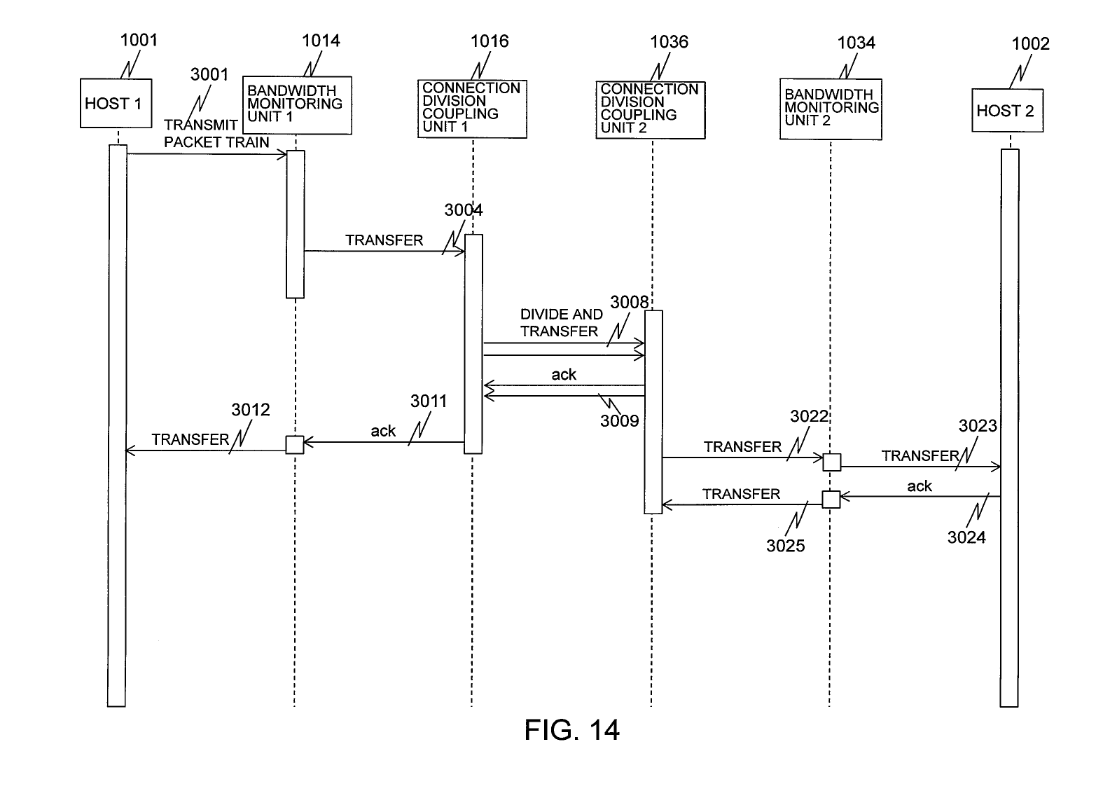

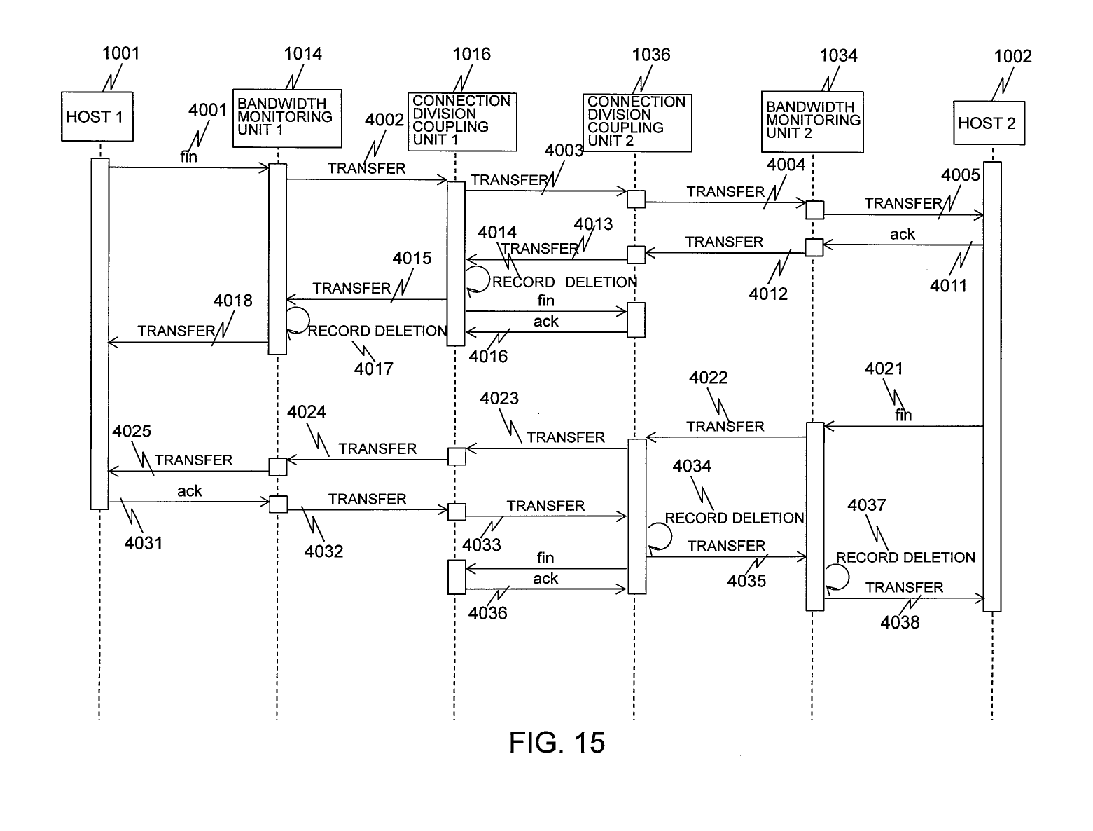

The details of this processing will be described with reference to FIG. 14. Thereafter, it is determined whether the communication is continued, or not, in the host 1 (1001) or the host 2 (1002) (17004). If continued, the flow returns to the steady state communication (17003), and if disconnected, connection disconnection processing (17005) is conducted, and the connection is terminated (17006). The determination (17004) and the connection disconnection processing (17005) may be conducted by any one of the host 1 (1001) and the host 2 (1002) without depending on which host starts the connection in Step 17002. The details (17005) of the connection disconnection processing are illustrated in FIG. 15.

Also, the WAN speed-up devices 1011 and 1031 periodically conduct a change necessity determination and change (17009) of the connection division number in the WAN speed-up devices 1011 and 1031. In the drawing, this step is illustrated in the flow from the connection start to the connection end, but may be asynchronous with those processing. This determination is conducted by, for example, the WAN speed-up device connected to the host that starts the connection. That is, when the host 1 (1001) starts the connection, the WAN speed-up device 1011 conducts the determination, and when the host 2 (1002) starts the connection, the WAN speed-up device 1031 conducts the determination. As a result of the determination, if the change is necessary, connection division number change processing is conducted. The number of divided connections in the steady state communication (17003) is changed by this processing.

(Operation flowchart)

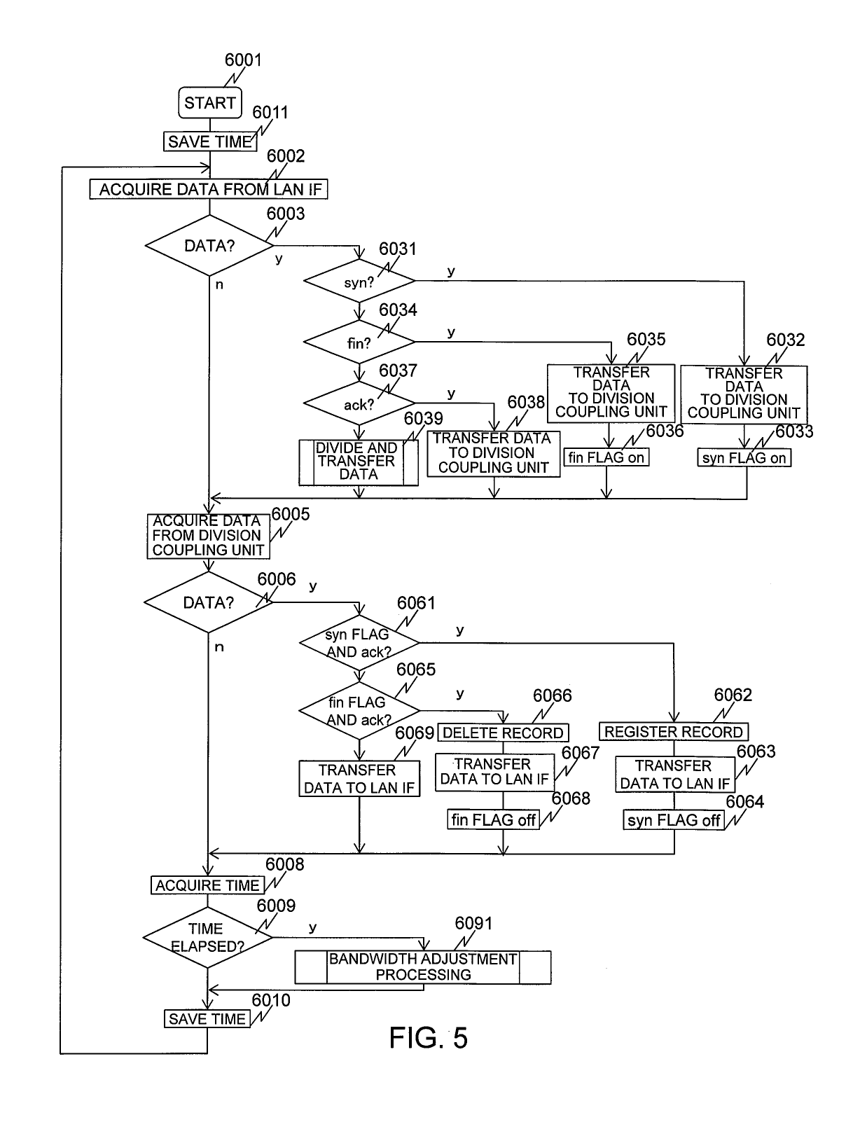

Subsequently, the installation of the bandwidth monitoring unit and the connection division coupling unit will be described with reference to flowcharts of FIGS. 5 to 12. The following description of the flowchart will be conducted mainly on the respective blocks such as the bandwidth monitoring unit 1014 and the connection division coupling unit 1016 of the WAN speed-up device 1011. The same is applied to the bandwidth monitoring unit 1034 and the connection division coupling unit 1036 in the WAN speed-up device 1031.

FIG. 5 is a flowchart of the bandwidth monitoring unit. After the processing starts (6001), the bandwidth monitoring unit 1014 saves the present time in a variable old_time (6010). Thereafter, the bandwidth monitoring unit 1014 acquires data from the LAN interface (6002), and conducts processing (6003 to 6039) corresponding to the data. Subsequently, the bandwidth monitoring unit 1014 acquires data from the connection division coupling unit 1016 (6005), and conducts processing corresponding to the data (6006 to 6069), and acquires a time (6008) to conduct bandwidth adjustment processing (6009, 6091). The bandwidth monitoring unit 1014 repeats the above loop. Hereinafter, the details of the respective processing will be described. The respective processing is executed by the bandwidth monitoring unit 1014.

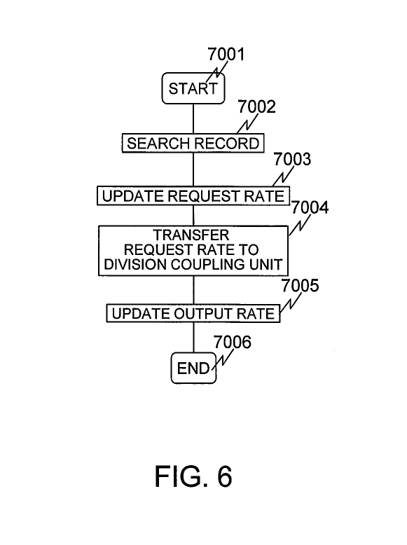

After having acquired data from the LAN interface (6002), it is first determined whether the data has been acquired, or not (6003). For example, if no data is accumulated in a buffer of the LAN interface, no data cannot be acquired, and it is determined that the processing further proceeds. If data is present, the processing proceeds on the basis of determination of whether the data is syn (6031), fin (6034), ack (6037), or others. The processing when the data is syn (6031, 6032, 6033) corresponds to message receptions 2001 and 2011 which will be described later, and a flag (syn flag) is so set to wait for a response from the connection division coupling unit 1016 after the received message has been transferred to the connection division coupling unit 1016. The processing when the data is fin (6034, 6035, 6036) corresponds to a message reception 4001 which will be described later, and a flag (fin flag) is so set to wait for a response from the connection division coupling unit 1016 after the received message has been transferred to the connection division coupling unit 1016. The processing when the data is ack (6037, 6038) corresponds to message receptions 2021, 3024, 4011, and 4031 which will be described later, and the received messages are transferred. Other processing correspond to a message reception 3001 which will be described later, and in this case, division transfer (6039) in FIG. 6 is conducted.

Subsequently, after the data has been acquired from the connection division coupling unit 1016 (6005), it is first determined whether the data could be acquired, or not (6006). If the data is present, the processing proceeds on the basis of the determination of whether the syn flag is raised, and ack has been received, or not (6061), whether the fin flag is raised, and ack has been received, or not (6065), and whether other cases are applied, or not. If the syn flag is raised, and ack has been received (6061, 6062, 6063, 6064), the processing corresponds to message receptions 2015 and 2025 which will be described later, a new record is registered in the bandwidth DB 1015, the data is transferred to the LAN interface 1012 (6063), and the syn flag is lowered. If the fin flag is raised, and ack has been received (6065, 6066, 6067, 6068), the processing corresponds to message receptions 4015 and 4035 which will be described later, the record of an appropriate connection is deleted from the bandwidth DB 1015, the data is transferred to the LAN interface 1012 (6067), and the fin flag is lowered. In other cases, the processing corresponds to message receptions 2005, 3011, 3022, 4004, and 4024 which will be described later, and the data is transferred to the LAN interface 1012 (6069).

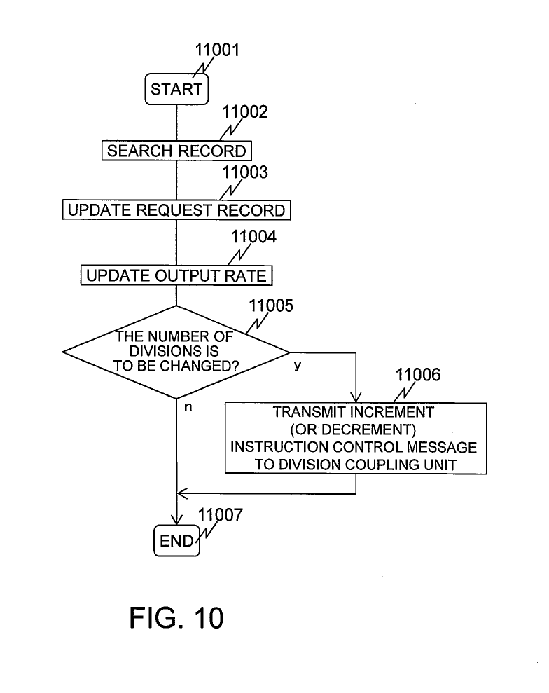

Subsequently, the present time is acquired (6008), and compared with the time saved in the variable old_time during the foregoing loop, and it is determined whether, for example, 1 sec or longer has been elapsed, or not (6009). If 1 sec or longer has been elapsed, bandwidth adjustment processing 6091 in FIG. 10 is conducted. Thereafter, the time acquired in Step 6008 is saved in the variable old_time, and the flow returns to Step 6002. A cycle in which the bandwidth adjustment processing is conducted may be an appropriate cycle other than 1 sec, or may be irregular.

FIG. 6 is a flowchart of the division transfer processing 6039 in the bandwidth monitoring unit. The respective processing is executed by the bandwidth monitoring unit 1014.

After the processing starts in the division transfer processing (7001), the bandwidth monitoring unit 1 (1014) searches the bandwidth DB 1015, and searches the record related to the connection that has received the data (7002). For example, the bandwidth monitoring unit 1 (1014) combines four columns of the LAN host IP column, the LAN host port column, the WAN host IP column, and the WAN host port column together to search the bandwidth DB 1015 on the basis of the respective data corresponding to the connections that have received the data, and searches the record related to the connection (3002).

Subsequently, the bandwidth monitoring unit 1 (1014) updates the request rate array of the record related to the connection and the last monitoring time (7003). For example, the last monitoring time is set to the present time, and the request rate array is determined on the basis of received data, for example, for last 1 sec.

Subsequently, the bandwidth monitoring unit 1 (1014) transfers a received packet train to the connection division coupling unit 1016 (7004). The transfer operation is influenced by the WAN interfaces 1013, 1033, and the WAN (1003) to change a required time. Subsequently, the bandwidth monitoring unit 1 (1014) measures the required time, updates the output rate array of the record related to the connection on the basis of the required time and the amount of transmitted data (7005), and terminates the processing (7006). As a result of this operation, the output rate of the connection is updated on the basis of, for example, a real amount of transmitted data (effective bandwidth).

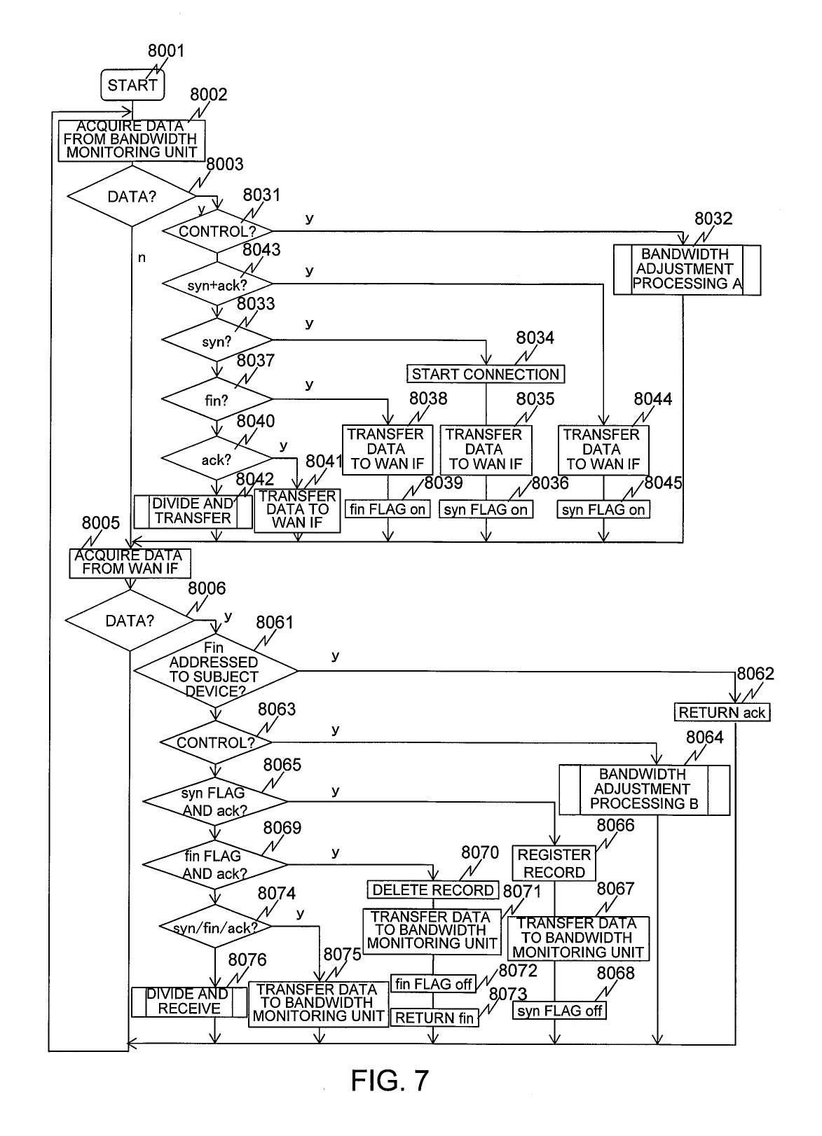

FIG. 7 is a flowchart of the connection division coupling unit. After the processing has started (8001), the connection division coupling unit 1016 acquires data from the bandwidth monitoring unit 1014 (8002) to conduct the processing corresponding to the acquired data (8003 to 8042), and subsequently acquires data from the WAN interface (8005) to conduct the processing (8006 to 8076) corresponding to the acquired data. The connection division coupling unit 1016 repeats the above loop. Hereinafter, the details of the respective processing will be described. The respective processing is executed by the connection division coupling unit 1016.

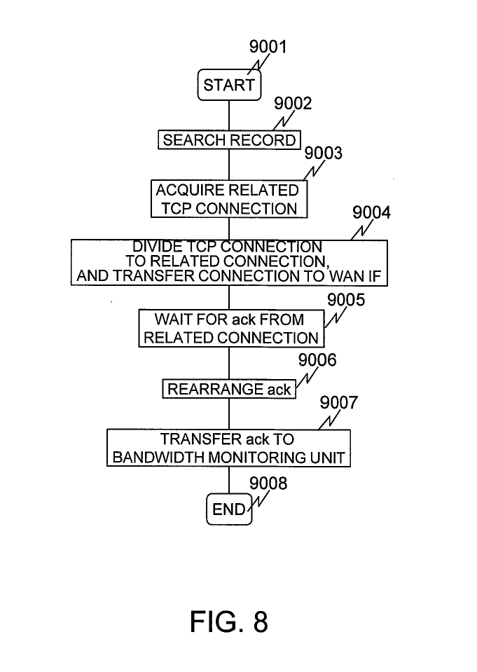

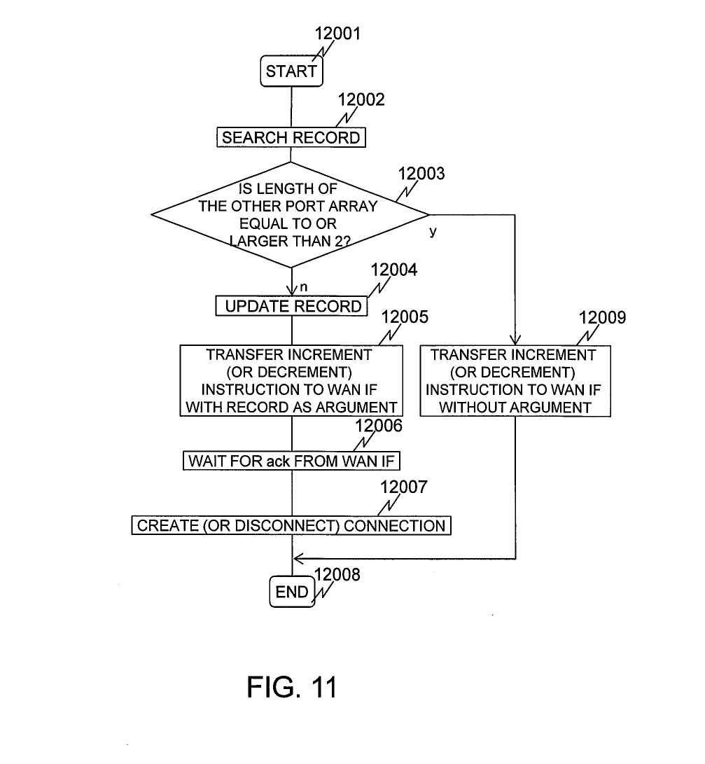

After having acquired the data from the bandwidth monitoring unit 1014 (8002), the connection division coupling unit 1016 first determines whether the data has been acquired, or not (8003). If the data is present, the connection division coupling unit 1016 proceeds with the processing on the basis of the determination of whether the data is a control message (8031), syn+ack (8043), syn (8033), fin (8037), ack (8040), or others. If the data is the control message (8031, 8032), the processing corresponds to a message reception 5005 which will be described later, and the connection division coupling unit 1016 conducts a bandwidth adjustment processing A (8032) of FIG. 11. If the data is syn+ack (8043, 8044, 8045), the processing corresponds to a message reception 2012 which will be described later, and the connection division coupling unit 1016 transfers the message to the WAN interface 1013, and raises the flag (syn flag) so as to wait for a response from the opposed connection division coupling unit 1036. If the data is syn (8033, 8034, 8035, 8036), the processing corresponds to a message reception 2002 which will be described later, and the connection division coupling unit 1016 transfers the message to the WAN interface 1013 after the connection has started, and raises the flag (syn flag) so as to wait for a response from the opposed connection division coupling unit 1036. If the data is fin (8037, 8038, 8039), the processing corresponds to message receptions 4003 and 4023 which will be described later, and the connection division coupling unit 1016 transfers the message to the WAN interface 1013 and raises the flag (fin flag) so as to wait for a response from the opposed connection division coupling unit 1036. If the data is ack, the processing corresponds to message receptions 2022, 4012, and 4032 which will be described later, and the connection division coupling unit 1016 transfers the message to the WAN interface 1013. In other cases, the processing corresponds to a message reception 3004 which will be described later, and the connection division coupling unit 1016 conducts division transfer processing 8042 of FIG. 8.

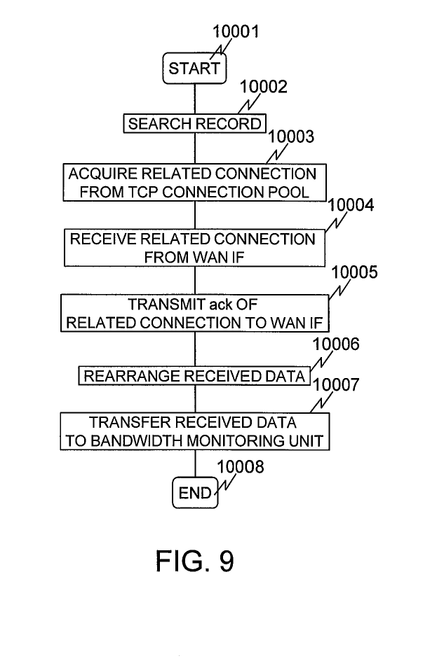

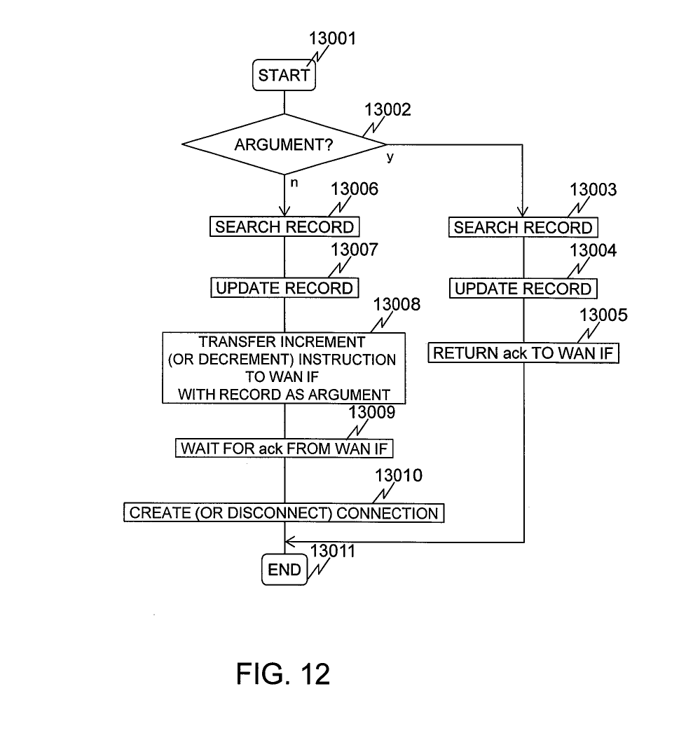

Subsequently, after having acquired the data from the WAN interface (8005), the connection division coupling unit 1016 first determines whether the data could be acquired, or not (8006). If the data is present, the connection division coupling unit 1016 proceeds with the processing on the basis of the determination of whether the data is the fin addressed to oneself (addressed to the subject device) (8061), the control message (8063), ack when the syn flag is raised (8065), ack when the fin flag is raised (8069), syn, fin or ack (8074), or others. If the data is the fin addressed to oneself (addressed to the subject device) (8061, 8062), the processing corresponds to message receptions 4016 and 4036 which will be described later, and the connection division coupling unit 1016 returns ack. If the data is the control message (8063, 8064), the processing corresponds to a message reception 5008 which will be described later, and the connection division coupling unit 1016 conducts a bandwidth adjustment processing B of FIG. 12 (8064). If the syn flag is raised, and the data is ack (8065, 8066, 8067, 8068), the processing corresponds to message receptions 2013 and 2023 which will be described later, the connection division coupling unit 1016 registers a new record in the connection division number DB 1017, and transfers the new record to the bandwidth monitoring unit 1014, and thereafter lowers the syn flag. If the fin flag is raised, and the data is ack (8069, 8070, 8071, 8072, 8073), the processing corresponds to message receptions 4013 and 4033 which will be described later, the connection division coupling unit 1016 deletes an appropriate record from the connection division number DB 1017, and transfers the record to the bandwidth monitoring unit 1014, and lowers the fin flag. Thereafter, the connection division coupling unit 1016 returns the fin to the opposed connection division coupling unit 1036. If the data is syn, fin, or ack (8074, 8075), the processing corresponds to processing 2004, 4003, and 4023 which will be described later, and the connection division coupling unit 1016 transfers the message to the bandwidth monitoring unit 1014. In other cases, the processing corresponds to a message reception 3008, and the connection division coupling unit 1016 conducts division receiving processing 8076 in FIG. 9.

FIG. 8 is a flowchart of the division transfer processing 8042 of the connection division coupling unit. The respective processing is executed by the connection division coupling unit 1016.

In Step 9002, the connection division coupling unit 1016 searches the connection division number DB 1017 to acquire the record. For example, the connection division coupling unit 1 (1016) searches the connection division number DB 1017 by combination of four columns of the LAN host IP column, the LAN host port column, the WAN host IP column, and the WAN host port column together, and searches the record related to the appropriate connection (connection that receives the data).

Subsequently, the connection division coupling unit 1016 specifies and acquires one or a plurality of related TCP connections (9003). For example, the connection division coupling unit 1016 specifies the divided connections established with respect to the opposed WAN speed-up device 1031 according to the searched record. The connection division coupling unit 1016 divides data in a round-robin fashion with respect to those connections, and transfers the data (9004). For example, the connection division coupling unit 1 (1016) divides the received packet train according to the connection division number column of the record related to the connection. As the division system, the round-robin or hash can be used. In this embodiment, the round-robin is applied for description. In the round-robin, packets are allowed to flow into the divided connections in order. The order of the divided connections is determined by, for example, sorting the combinations of the subject port array and the other port array in the connection division number DB 1017 in ascending order of numbers. For example, in the case of a record 15002 of the table 15001, a first connection is [8013-4759] in the combination of the ports, and a second connection is [10129-4759] in the combination of the ports.

Thereafter, the connection division coupling unit 1 (1016) waits for reception of ack (9005). The connection division coupling unit 1 (1016) sorts the received ack in sequence numerical order of the TCPs (9006), transfers the ack to the bandwidth monitoring unit 1 (1014) (9007), and terminates the processing. In this example, although an arrival order of ack is somewhat unsteady due to an influence of a congestion control of the TCP, ack is returned substantially in the packet transfer order. For that reason, sorting can be conducted if merge sorting is conducted every time data is acquired from the respective divided connections in the round-robin fashion.

FIG. 9 is a flowchart of division receiving processing of the connection division coupling unit.

After having searched the connection division number DB 1017 to acquire the record in Step 10002, the connection division coupling unit 1 (1016) specifies and acquires one or a plurality of related TCP connections (10003), and receives data from the TCP connections in the round-robin fashion (10004), and returns ack (10005). Thereafter, the connection division coupling unit 1 (1016) sorts the received data in the sequence numerical order of the TCP (10006), transfers the data to the bandwidth monitoring unit 1 (1014) (10007), and terminates the processing. Also, in the sort (10006), the merge sorting can be conducted in the same technique as that of the above-mentioned sort.

FIG. 10 is a flowchart of the bandwidth adjustment processing 6091 of the bandwidth monitoring unit.

In the bandwidth adjustment processing 6091, after the processing starts (11001), the bandwidth monitoring unit 1014 searches a certain record (arbitrary record) from the bandwidth DB 1015 (11002).

Then, the bandwidth monitoring unit 1014 updates the request rate array, the output rate array, and the last monitoring time within the record with the use of the present time, updates an average of the request rates (11003), and also updates an average of the output rates (11004). For example, the bandwidth monitoring unit 1014 updates the request rate array on the basis of the amount of received data, and updates the output rate array on the basis of the amount of transmitted data.

Subsequently, the bandwidth monitoring unit 1014 determines whether the number of divisions needs to be changed, or not (11005). In an example of the table 14001, the moving average of the request rates is 12.4 packets/sec, and the moving average of the output rates is also 7.2 packets/sec. Subsequently, it is determined whether the number of divisions needs to be changed, or not (5004). As an example, the bandwidth monitoring unit 1014 determines that if the request rate is larger than the output rate by 20% (first threshold value) or larger, there is a need to increment the number of divisions by one, and if the request rate is 0 packets/sec (second threshold value), there is a need to decrement the number of divisions by one. The bandwidth monitoring unit 1014 also determines that, in other cases, there is no need to increment or decrement the number of divisions. In this embodiment, the threshold value is set to 20% and 0 packets/sec. However, other threshold values may be used as a value of the system definition or the user definition. In the example of the table 14001, because the request rate is larger than the output rate by 20%, the bandwidth monitoring unit 1014 determines that there is a need to increment the number of divisions by one. If the number of divisions needs to be changed as a result of the determination, the bandwidth monitoring unit 1014 transmits an instruction for incrementing the number of divisions (a decrement instruction if the number of divisions is decreased) to the connection division coupling unit (11006). Thereafter, the bandwidth monitoring unit 1014 terminates the processing (11007).

FIG. 11 is a flowchart of the bandwidth adjustment processing A (8032) of the connection division coupling unit. For example, FIG. 11 is a flowchart when the increment instruction is received from the bandwidth monitoring unit.

The connection division coupling unit 1 (1016) searches the record related to the connection that receives the data with reference to the connection division number DB 1017 in the same manner as that described above (12002). In Step 12003, it is determined whether a length of the other port array is equal to or larger than 2, or not. The connection division coupling unit 1 (1016) updates the record (12004) unless the length of the other port array is equal to or larger than 2 (12003). For example, the control data is the increment instruction from the bandwidth monitoring unit 1 (1014), and the connection division coupling unit 1 (1016) increments a value of the connection division number column with respect to the record of the connection division number DB 1017, and adds a free port No. to the subject port array because the length of the other port array is, for example, 1.

Then, the connection division coupling unit 1 (1016) transmits the increment instruction to the connection division coupling unit 2 (1036) through the WAN interface 1013 with the contents of the record updated by the record update 12004 as an argument. In this example, the communication uses the control connection. The connection division coupling unit 1 (1016) waits for ack from the connection division coupling unit 2 (1036) through the WAN interface 1013 (12006). Thereafter, the connection division coupling unit 1 (1016) conducts 3-way handshake with respect to the connection division coupling unit 2 (1036), and establishes a new TCP connection (12007).

Also, Step 12009 is the processing when the length of the other port array is equal to or larger than 2 (12003), and the connection division coupling unit 1 (1016) transmits the increment (or decrement) instruction of the argument to the connection division coupling unit 2 (1036) through the WAN interface 1013.

FIG. 12 is a flowchart of the bandwidth adjustment processing B of the connection division coupling unit. For example, FIG. 12 is a flowchart when the increment instruction is received from the opposed connection division coupling unit.

In Step 13002, it is determined whether the argument is present in the received data (for example, increment instruction), or not, and if no argument is present, the connection division coupling unit 1 (1016) conducts Steps 13006 to 13010. These steps are identical with the above-mentioned Steps 12002, 12004 to 12007. That is, the increment (or decrement) processing is conducted oppositely.

On the other hand, if the argument is present (13002), the connection division coupling unit 1 (1016) conducts Steps 13003 to 13005. In Step 13003, the connection division coupling unit 1 (1016) searches the record related to the above connection, and updates the record according to the increment instruction (13004). For example, the connection division coupling unit 1 (1016) increments a value of the connection division number column. Also, the connection division coupling unit 1 (1016) returns ack to the WAN IF 1013 (13005).

### (Operation Sequence)

Hereinafter, the details of the respective processing illustrated in FIG. 4 will be described with reference to sequence diagrams of FIGS. 13 to 16. In order to distinguish two bandwidth monitoring units from each other, the bandwidth monitoring unit 1014 is called “bandwidth monitoring unit 1”, and the bandwidth monitoring unit 1034 is called “bandwidth monitoring unit 2”. Also, in order to distinguish the two connection division coupling units from each other, the connection division coupling unit 1016 is called “connection division coupling unit 1”, and the connection division coupling unit 1036 is called “connection division coupling unit 2”. Further, in the drawing, the connection division coupling unit 1016 (and 1036) is abbreviated to “division coupling unit”. Further, the TCP connection management method of the host 1 and the host 2 will not be described in detail because the existing method is used, and the WAN speed-up devices 1011 and 1031 inserted between the host 1 and the host 2, and the operation of their internal operation modules will be exclusively described.

FIG. 13 is a processing sequence example when a new TCP connection starts between the host 1 (1001) and the host 2 (1002). In this example, the host 1 (1001) starts the connection processing. In the connection start of the TCP, there is used a technique called “3-way handshake” in which a syn packet is transmitted from the host 1 to the host 2, the host 2 then returns a syn+ack packet to the host 1 responsive to the syn packet, and the host 1 further returns an ack packet to the host 2.

First, the host 1 (1001) transmits the syn packet to the bandwidth monitoring unit 1 (1014) through the LAN interface 1012 (2001). In this example, because the intervention of the LAN interface 1012 would be obvious, the LAN interface 1012 (and 1032) will be omitted in FIG. 13 and the description of the processing in this embodiment. Also, for the same reason, the WAN interface 1013 (and 1033) will be also omitted. The bandwidth monitoring unit 1 (1014) transfers the received syn packet to the connection division coupling unit 1 (1016) (2002), and waits for a response from the connection division coupling unit 1 (1016).

Subsequently, the connection division coupling unit 1 (1016) connects the TCP connection for a proxy communication with respect to the connection division coupling unit 2 (1036) (2003). Also, in this situation, the processing of the 3-way handshake is conducted. Thereafter, the connection division coupling unit 1 (1016) transfers the received syn packet to the connection division coupling unit 2 (1036) with the use of the connection connected in Step 2003 (2004), and waits for a response from the connection division coupling unit 2 (1036).

Subsequently, the connection division coupling unit 2 (1036) transfers the received syn packet to the bandwidth monitoring unit 2 (1034) (2005). Subsequently, the bandwidth monitoring unit 2 (1034) transfers the received syn packet to the host 2 (1002) (2006).

Then, the host 2 (1002) transmits the syn+ack packet to the bandwidth monitoring unit 2 (1034) (2011). The bandwidth monitoring unit 2 (1034) transfers the received syn+ack packet to the connection division coupling unit 2 (1036) (2012), and waits for a response from the connection division coupling unit 2 (1036). Subsequently, the connection division coupling unit (1036) transfers the received syn+ack packet to the connection division coupling unit 1 (1016) that waits for the response with the use of the connection connected in Step 2003 (2013), and waits for a response from the connection division coupling unit 1 (1016). Subsequently, the connection division coupling unit 1 (1016) registers the record related to the above connection in the connection division number DB 1017 (2014), transfers the received syn+ack packet to the bandwidth monitoring unit 1 (1014) that waits for the response (2015), and releases a response wait state. Subsequently, the bandwidth monitoring unit 1 (1014) registers the record related to the above connection in the bandwidth DB 1015 (2016), transfers the received syn+ack packet to the host 1 (1001) (2017), and releases the response wait state.

Finally, the host 1 (1001) transmits the ack packet to the bandwidth monitoring unit 1 (1014) (2021). Subsequently, the bandwidth monitoring unit 1 (1014) transfers the received ack packet to the connection division coupling unit 1 (1016) (2022). Subsequently, the connection division coupling unit 1 (1016) transfers the received ack packet to the connection division coupling unit 2 (1036) that waits for the response with the use of the connection connected in Step 2003 (2023). Subsequently, the connection division coupling unit 2 (1036) registers the record related to the above connection in the connection division number DB 1037 (2024), transfers the received ack packet to the bandwidth monitoring unit 2 (1034) that waits for the response (2025), and releases a response wait state. Subsequently, the bandwidth monitoring unit 2 (1034) registers the record related to the above connection in the bandwidth DB 1035 (2026), transfers the received ack packet to the host 2 (1002) (2027), and releases the response wait state.

In the above processing flow, the WAN speed-up devices 1011 and 1031 inserted between the host 1 (1001) and the host 2 (1002) can start the proxy connection of the above connection, and register management information related to the above connection in the DB while conducting the communication processing of the 3-way handshake by proxy.

FIG. 14 is a processing sequence example when communicating data between the host 1 (1001) and the host 2 (1002) with the use of the TCP connection that starts in FIG. 13. In this example, the host 1 (1001) transmits the data to the host 2 (1002). The same is applied to the reverse direction. At a time point of FIG. 13, the number of TCP connections between the connection division coupling units 1 (1016) and 2 (1036) is only one line. However, in this example, it is assumed that the number of TCP connections is two lines. A procedure related to an increase or decrease in the number of TCP connections between the connection division coupling units 1 (1016) and 2 (1036) is described above.

First, the host 1 (1001) transmits the packet train to the bandwidth monitoring unit 1 (1014) (3001). The bandwidth monitoring unit 1 (1014) receives the packet train as long as a buffer size at a maximum. The bandwidth monitoring unit 1 (1014) transfers the received packet train to the connection division coupling unit 1 (1016) according to the processing illustrated in FIGS. 5 and 6 (3004).

The connection division coupling unit 1 (1016) divides the received packet train according to the processing illustrated in FIGS. 7 and 8, transfers the divided packet train with the use of an appropriate connection (3008), and waits for reception of ack (3009). Subsequently, the connection division coupling unit 1 (1016) sorts the received ack in the sequence numerical order of the TCP, and transfers the ack to the bandwidth monitoring unit 1 (1014) (3011). Thereafter, the bandwidth monitoring unit 1 (1014) transfers ack to the host 1 (1001) (3012).

On the other hand, the connection division coupling unit 2 (1036) to which the packet train has been transferred with the use of the plurality of connections (3008) returns ack (3009). Thereafter, the connection division coupling unit 2 (1036) sorts the received packet trains in the sequence numerical order of the TCP, and transfers the packet trains to the bandwidth monitoring unit 2 (1034) (3022) according to the processing illustrated in FIGS. 7 and 9.

Subsequently, the bandwidth monitoring unit 2 (1034) transfers the received packet train to the host 2 (1002) according to the processing illustrated in FIG. 5 (3023). The host 2 (1002) returns ack to the bandwidth monitoring unit 2 (1034) according to a control of the TCP (3024), and the ack is transmitted to the connection division coupling unit 2 (1036) to terminate the processing.

In the above processing flow, the WAN speed-up devices 1011 and 1031 inserted between the host 1 (1001) and the host 2 (1002) can speed up the data communication between the host 1 (1001) and the host 2 (1002) with the use of a plurality of TCP connections.

FIG. 15 is a processing sequence example when the TCP connections are terminated between the host 1 (1001) and the host 2 (1002). In this example, the host 1 (1001) starts connection termination processing. The connection termination processing of the TCP is conducted in a procedure in which the fin packet is transmitted from the host 1 to the host 2, the host 2 then returns the ack packet responsive to the fin packet, the fin packet is further transmitted from the host 2 to the host 1 after data to be transmitted from the host 2 to the host 1 disappears, and the host 1 then returns the ack packet responsive to the fin packet.

First, the host 1 (1001) transfers the fin packet to the bandwidth monitoring unit 1 (1014) (4001). The respective modules propagate the fin packet (4002, 4003, 4004, 4005), and the fin packet arrives at the host 2 (1002). In a propagation process, the bandwidth monitoring unit 1 (1014) waits for the response from the connection division coupling unit 1 (1016) and the connection division coupling unit 1 (1016) waits for the response from the connection division coupling unit 2 (1036), respectively.

Subsequently, the host 2 (1002) transfers the ack packet to the bandwidth monitoring unit 2 (1034) (4011). The ack packet is propagated (4012, 4013) to the connection division coupling unit 1 (1016) as with the above case. The connection division coupling unit 1 (1016) deletes the record related to the appropriate connection from the connection division number DB 1017 (and 1037) (4014), and transfers the record to the bandwidth monitoring unit 1 (1014) (4015). Then, the connection division coupling unit 1 (1016) transfers fin-ack with respect to the respective divided connections to the connection division coupling unit 2 (1036) (4016), prepares for connection disconnection, and releases a response wait state. Similarly, the bandwidth monitoring unit 1 (1014) deletes the record related to the above connection from the bandwidth DB 1015 (4017), transfers the record to the host 1 (1001) (4018), and releases the response wait state.

Thereafter, the bandwidth monitoring unit 1 (1014) transfers the fin packet and the ack packet with the host 2 (1002) as an origin (4021 to 4038).

In the above processing flow, the WAN speed-up devices 1011 and 1031 inserted between the host 1 (1001) and the host 2 (1002) can terminate the divided connections between the connection division coupling units 1 (1016) and 2 (1036) by transfer of fin-ack in 4016 and 4036, while conducting the transfer of fin-ack by proxy.

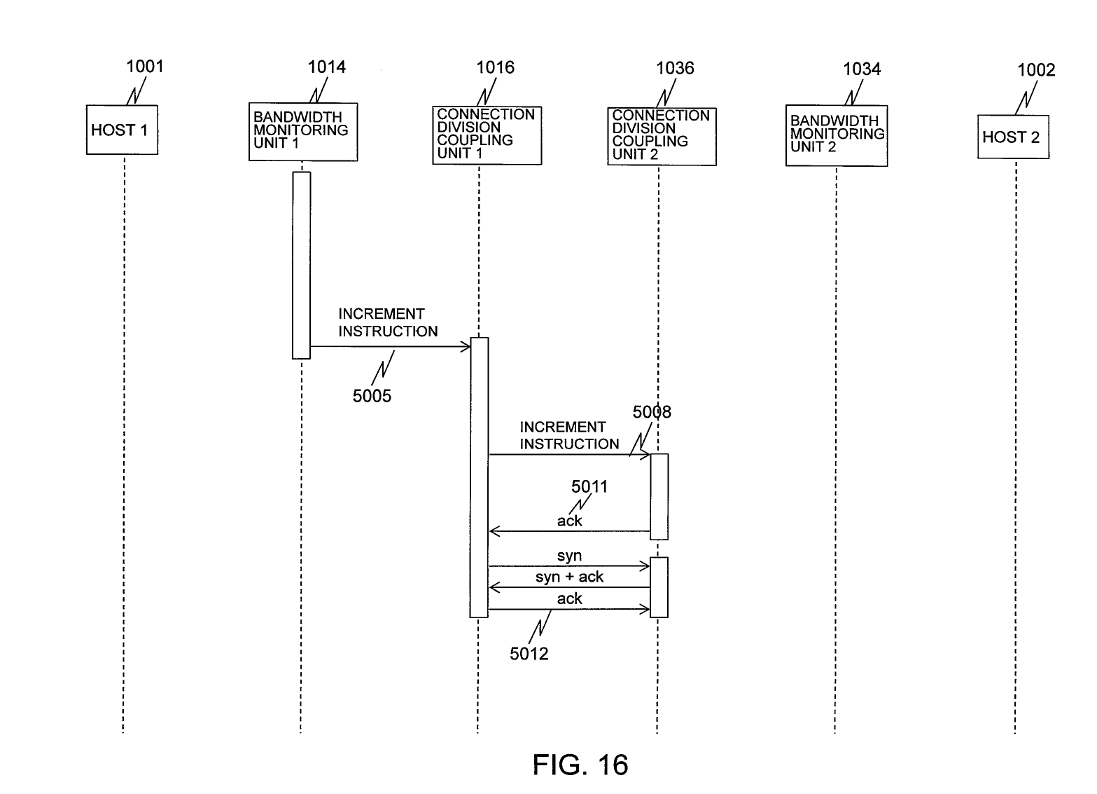

FIG. 16 is an example of a reviewing sequence of the number of divided connections between the connection division coupling units 1 (1016) and 2 (1036). This processing is conducted on all of the connections which are executed by the WAN speed-up devices 1 (1001) and 2 (1002) by proxy, for example, conducted on all of the connections in chronological order of registration into the bandwidth DB 1015. FIG. 16 illustrates a portion related on a certain connection among all of the connections.

First, the bandwidth monitoring unit 1 (1014) transmits an instruction 5005 for incrementing the number of divisions to the connection division coupling unit 1 (1016).

The connection division coupling unit 1 (1016) transmits the increment instruction with the contents of the updated record as an argument according to the processing illustrated in FIG. 11 (5008). In this example, the communication uses the control connection. Subsequently, the connection division coupling unit 2 (1036) returns ack to the connection division coupling unit 1 (1016) according to the processing illustrated in FIG. 11 (5011). Thereafter, the 3-way handshake is conducted between the connection division coupling units 1 (1016) and 2 (1036) to establish a new TCP connection (5012).

In updating the record (5007), if the length of the other port array is equal to or larger than 2, the connection division coupling unit 1 (1016) does not conduct the update of the record, and transmits only an increment instruction 5008 to the connection division coupling unit 2 (1036). Thereafter, the connection division coupling unit 2 (1036) searches its own free port, and adds the free port to the subject port array to conduct the record update processing. Thereafter, the connection division coupling unit 2 (1036) returns the increment instruction to the connection division coupling unit (1016). That is, the increment processing is conducted reversely from FIG. 16.

In the above processing flow, the number of divided connections between the connection division coupling units 1 (1016) and 2 (1036) can be reviewed to increment the number of divided connections. Also, when a last connection start processing 5012 can be changed to the connection termination processing to decrement the number of divided connections.

The configuration of FIG. 1 is taken by using the WAN speed-up device installing the above processing steps, thereby being capable of speeding up the communication between the host 1 (1001) and the host 2 (1002).

### Second Embodiment

In this example, a description will be given of an example of the WAN speed-up device having a mechanism that improves the determination of whether the number of divisions needs to be changed, or not, and avoids an unnecessary increase in the number of connections between the WAN speed-up devices 1011 and 1031.

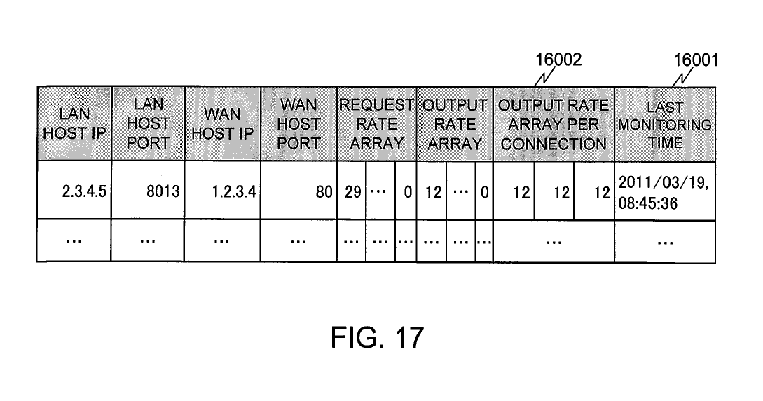

FIG. 17 is an example of the schema and record in the bandwidth DB 1015 (and 1035) of the WAN speed-up device 1011 (and 1031) according to a second embodiment. A schema 16001 of the bandwidth DB is designed to add an “output rate array per connection” column 16002 to the schema of the bandwidth DB in the first embodiment. It is assumed that an n^{th} value of the array of the column 16002 is a maximum value of the output rate per connection when the connection is divided by n, and the present number of divisions is an array length. In the example illustrated in the figure, when a leftmost array is 1 in the number of divisions, the number of divisions become 2, . . . n in order. For example, if the number of divisions is further increased, the number of arrays is increased, and if the number of divisions is decreased, the number of arrays is also decreased. With this configuration, a rightmost array in the figure becomes a value in the present number of divisions. In the WAN speed-up device 1011 (and 1031) of FIG. 1, the configurations denoted by identical reference numerals or symbols illustrated in FIG. 1 already described, and the portions having the same functions will be omitted from the description.

Hereinafter, a method of updating the column 16002 will be described. When the output rate is updated in Step 5003 (and 11004), a value obtained by dividing the present output rate by the array length (that is, the present number of divisions) is compared with an end (that is, a maximum value in the present number of divisions) of the column 16002. If the value obtained by dividing the present output rate by the array length is larger, the end of the column 16002 is updated by the value obtained by dividing the present output rate by the array length. That is, the maximum value of the output rate per connection is stored. Also, if the increment instruction is output in Step 5005 (and 11006), the array length of the column 16002 is incremented by one, and if the decrement instruction is output, the array length of the column 16002 is decremented by one.

Hereinafter, a description will be given of a method of determining whether the number of divisions needs to be changed, or not, using the column 16002. In determination in Step 5004 (and 11005), a value of the end (that is, an output rate maximum value per present connection) of the array is compared with a value next to the end (that is, an output rate maximum value per connection when the number of divisions is smaller by one) with reference to the column 16002. If the value of the end of the array is smaller than the value next to the end by, for example, 20% or larger (or if their ratio is smaller than a threshold value), it is determined that the division is unnecessary (the division is not allowed). For example, in this case, it is assumed that even if the number of divisions is increased, the effective bandwidth is not largely improved. Aside from 20%, a predetermined appropriate threshold value (third threshold value) may be used.

The configuration of FIG. 1 is taken by using the WAN speed-up device installing the above processing steps, thereby being capable of speeding up the communication between the host 1 (1001) and the host 2 (1002) while avoiding an unnecessary increase in the number of connections between the WAN speed-up devices 1011 and 1031.

### Third Embodiment

In this embodiment, the bandwidth monitoring programs 1014 and 1034, the bandwidth DBs 1015 and 1035, the connection division coupling programs 1016 and 1036, and the connection division number DBs 1017 and 1037 which are required for the operation of the WAN speed-up devices 1011 and 1031 are read in the secondary storages 1019 and 1039 before the system operates, for example, when the system is installed or starts, to thereby enable the operation using the general-purpose server device.

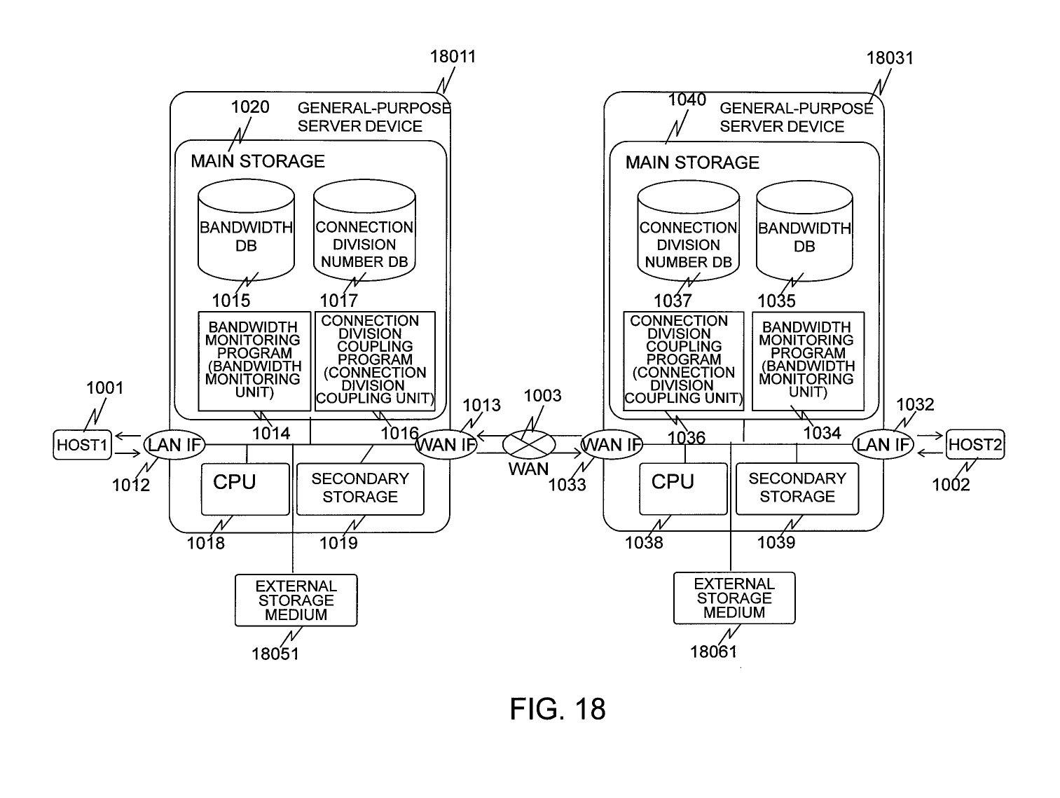

FIG. 18 is an exemplary configuration diagram of the communication system using the general-purpose server device according to a third embodiment. In the third embodiment, a procedure of reading the bandwidth monitoring programs 1014 (and 1034), the bandwidth DB 1015 (and 1035), the connection division coupling programs 1016 (and 1036), and the connection division number DB 1017 (and 1037) in the secondary storage 1019 (and 1039) of a general-purpose server device 18011 (and 18031) with the use of an external storage medium 18051 (and 18061) such as a CD-ROM, is conducted after the general-purpose server device 18011 (and 18031) has been installed.

In the third embodiment, the external storage medium is used to read the respective programs and DBs in the general-purpose server device 18011 (and 18031). Also, the same effects can be obtained even if the respective programs and DBs are downloaded from another server device or a file server on the network 1033.

The configuration of FIG. 18 is taken by executing the above processing steps and using the general-purpose server device, thereby being capable of speeding up the communication between the host 1 (1001) and the host 2 (1002).

### Fourth Embodiment

In this embodiment, the function of the WAN speed-up device 1011 and the function of the host 1 (1001), and/or the function of the WAN speed-up device 1031 and the function of the host 2 (1002) according to the first embodiment, the second embodiment, or the third embodiment operate within the same general-purpose server device.

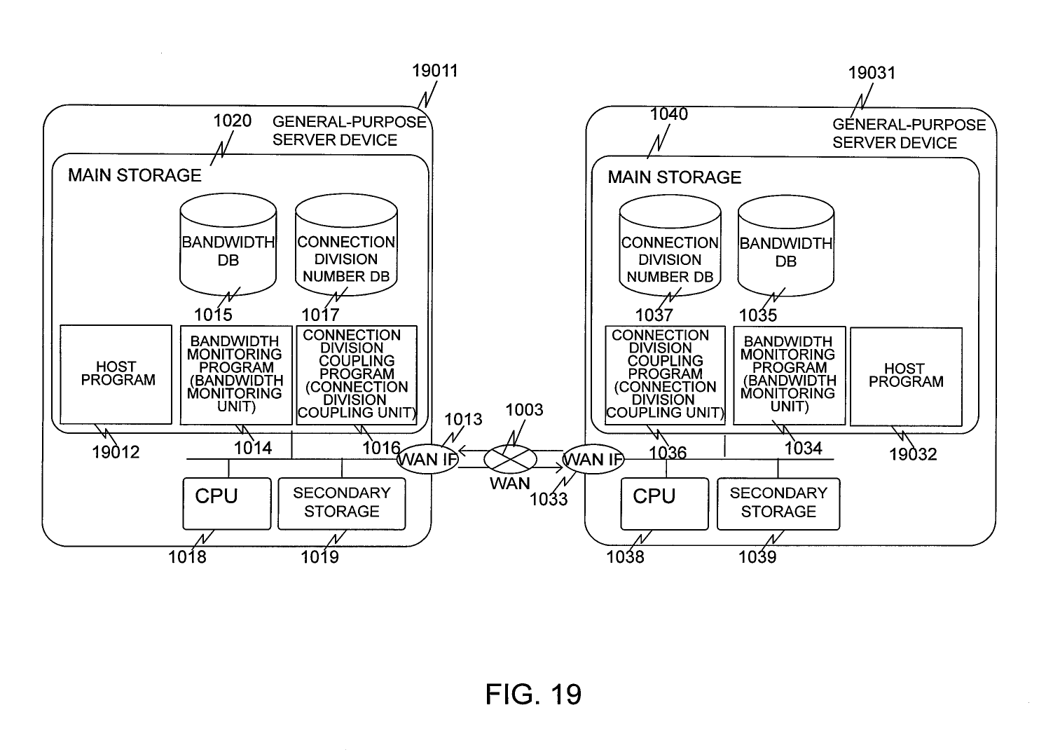

FIG. 19 is an exemplary configuration diagram of a communication system using the general-purpose server device in which the function of the WAN speed-up and the function of the host operate within the same device according to a fourth embodiment. In the fourth embodiment, a host program 19012 (and 19032) necessary for the operation of the host 1 (1001) (and the host 2 (1002)) according to the first embodiment, the bandwidth monitoring program 1014 (and 1034) and the connection division coupling program 1016 (and 1036) necessary for the operation of the WAN speed-up device operate by a general-purpose server device 19011 (and 19031). Also, the main storage 1020 (and 1040) includes the bandwidth DB 1015 (and 1035) and the connection division number DB 1017 (and 1037) necessary for the operation of the bandwidth monitoring program 1014 (and 1034) and the connection division coupling program 1016 (and 1036). Also, in the third embodiment, the host program 19012 (and 19032) and the bandwidth monitoring program 1014 (and 1034) communicate with each other by using a loop back device available by a large number of general-purpose server devices instead of the LAN IF 1012 (and 1032) of the first embodiment. In the fourth embodiment, the respective programs and DBs are saved in the secondary storage 1019 (and 1039), and read in the main storage 1020 (and 1040) after the general-purpose server device 19011 (and 19031) starts. However, the same effects can be obtained even if the respective programs and DB are read from the external storage medium as in the third embodiment, or downloaded from another server device or a file server on the network.

The configuration of FIG. 19 is taken by executing the above processing steps and using the general-purpose server device in which the WAN speed-up device and the host operate within the same device, thereby being capable of speeding up the communication between the host program 19012 and the host program 19032.

### Configuration Example

### Configuration Example 1

### Method of Controlling a Device for Determining the Number of TCP Divisions on the Basis of Effective Bandwidth

There is provided a method of controlling a network proxy device, including:

a storage area A that holds the respective moving averages of a request rate for each TCP connection, and an output rate at which transfer can be conducted to a network; and

a storage device B that holds the number of divided connections for each connection requested by a host, and identification information on each of the divided connections,

in which a control is conducted so that the request rate and the output rate in the storage area A are compared with each other according to a rule of a user definition or a system definition,

the number of divided connections is increased or decreased as occasion demands,

when the number of divided connections is increased, a new TCP connection C starts, the number of divided connections in the storage area B, and the identification information in the connection C are updated, and

when the number of divided connections is decreased, an arbitrary TCP connection D is acquired from the storage area B, the TCP connection D is terminated, and the number of divided connections in the storage area B and the identification information in the connection C are updated.

### Configuration Example 2

There is provided the method of controlling a network proxy device according to the configuration example 1,

in which the rule for comparing the request rate with the output rate with the use of a threshold value A and a threshold value B of the user definition or the system definition is that if the request rate is larger than the output rate by the threshold value A or larger, the number of divisions is incremented by one, and if the request rate is smaller than the threshold value B, the number of divisions is decremented by one.

### Configuration Example 3

### WAN Speed-Up for Determining the Number of TCP Divisions on the Basis of the Effective Bandwidth

There is provided a network proxy device, including:

a storage area A that holds the respective moving averages of a request rate for each TCP connection, and an output rate at which transfer can be conducted to a network; and

a storage device B that holds the number of divided connections for each connection requested by a host, and identification information on each of the divided connections, and

a control is conducted to increment or decrement the number of divided connections in the method according to the configuration example 2.

### Configuration Example 4

### System Using a Device for Determining the Number of TCP Divisions on the Basis of the Effective Bandwidth

There is provided a system in which a host 1 and a host 2 communicate with each other through a wide area network,

in which a network proxy 1 and a network proxy 2 according to the configuration example 3 are installed between the host 1 and the host 2,

the network proxy 1 is arranged physically in the vicinity of the host 1, and

the network proxy 2 is also arranged physically in the vicinity of the host 2.

### Configuration Example 5

### Method Based on the Effective Bandwidth, and the Effective Bandwidth Per Connection

There is provided the method of controlling the network proxy device according to the configuration example 2, in which

the storage area A further holds a maximum value of the output rate per divided connection for each number of divisions by using a threshold value C of the user definition or the system definition, and

a control is conducted so that when it is determined that the number of divisions is incremented by one,

the output rate maximum value per the present connection is compared with the output rate maximum value per connection when the number of divisions is smaller by one, and

only when their ratio is smaller than the threshold value C, the number of divisions is incremented by one.

The present invention can be applied to a system using, for example, a TCP communication.

What is claimed is:

1. A network device that relays a TCP communication through a first network and a second network between hosts, the network device comprising:
a first storage area that holds, for each TCP connection between the hosts, a request rate based on an amount of data input from the first network, and an output rate indicative of an effective bandwidth at which data is transferred to the second network;
a connection division coupling unit that, for each TCP connection between the hosts, divides data from the first network into a plurality of connections established with respect to an opposed network device in the second network, and transfers the divided connections, and couples data from the second network through the plurality of connections together, and transfers the coupled data to the first network;
a second storage area that holds the number of divided connections; and
a bandwidth monitoring unit that increases or decreases the number of divided connections on the basis of the request rate and the output rate.

2. The network device according to claim 1, wherein
the bandwidth monitoring unit compares the request rate with the output rate, and increases the number of divided connections if the request rate is equal to or larger than the output rate by a predetermined first threshold value.

3. The network device according to claim 1, wherein
the bandwidth monitoring unit decreases the number of divided connections if the request rate is smaller than a predetermined second threshold value.

4. The network device according to claim 1, wherein
when the number of divided connections is increased,
a new connection is established with respect to the opposed network device through the second network, and
the number of divided connections in the second storage area is updated, and identification information of the established connection is stored.

5. The network device according to claim 1, wherein
when the number of divided connections is decreased,
one of the connections corresponding to an appropriate TCP connection is selected from the second storage area,
processing of terminating the selected connection is conducted with respect to the opposed network device through the second network, and
the number of divided connections in the second storage area is updated, and identification information on the selected connection is deleted.

6. The network device according to claim 1, wherein
the bandwidth monitoring unit monitors the request rate per unit time based on an amount of data input within the unit time, and the output rate per unit time based on an amount of data transferred within the unit time, and obtains respective moving averages of the monitored request rate and the monitored output rate over a plurality of unit times as the request rate and the output rate.

7. The network device according to claim 1, wherein
the first storage area further holds a maximum value of the output rate per connection monitored when the connection has been divided into the number of divided connections in the past, wherein
when it is determined whether the number of divisions is increased or not, a maximum value of the output rate per connection in the present number of divided connections is compared with an output rate maximum value per connection in the number of divided connections smaller by one, and if its ratio is smaller than a predetermined third threshold value, it is determined that the division is unnecessary.

8. A method of controlling a network device that relays a TCP communication through a first network and a second network between hosts, the method including steps of:
storing, for each TCP connection between the hosts, a request rate based on an amount of data input from the first network, and an output rate indicative of an effective bandwidth at which data is transferred to the second network in a first storage area;
dividing, for each TCP connection between the hosts, data from the first network into a plurality of connections established with respect to an opposed network device in the second network, and transfering the divided connections, and coupling data from the second network through the plurality of connections together, and transfering the coupled data to the first network; and
increasing or decreasing the number of divided connections on the basis of the request rate and the output rate.

9. A network system in which a first host and a second host communicate with each other through a wide area network, the network system comprising:
a first network device according to claim 1 which is arranged on the first host side; and
a second network device according to claim 1 which is arranged on the second host side, wherein
the first network device and the second network device are arranged through the wide area network, and
the first host and the second host communicate with each other through a connection divided on the basis of an effective bandwidth of the wide area network.

10. A network system in which a first host and a second host communicate with each other through a wide area network, the network system comprising:
a first general purpose server device which is arranged on the first host side;
a second general purpose server device which is arranged on the second host side;
a first external storage medium that stores a program that executes a method according to claim 8, and related data therein, which is arranged on the first general purpose server device side; and
a second external storage medium that stores a program that executes a method according to claim 8, and related data therein, which is arranged on the second general purpose server device side, wherein
the first general purpose server device and the second general purpose server device are arranged through the wide area network,
the program and the related data are copied into the first general purpose server device from the first external storage medium,
the program and the related data are copied into the second general purpose server device from the second external storage medium, and
the first host and the second host communicate with each other through a connection divided on the basis of an effective bandwidth of the wide area network.

11. The network system according to claim 10, wherein
the first general purpose server device is the first host, and
the second general purpose server device is the second host.
